(19) United States
(12) Patent Application Publication
(10) Pub. No.: US 2021/0174508 A1
(43) Pub. Date: Jun. 10, 2021

(54) SYSTEM AND METHOD FOR PRODUCING A MULTIPARAMETER GRAPHIC INDICATOR FROM AN IMAGE OF A HISTOLOGICAL SECTION

(71) Applicant: Biocellvia, Marseille (FR)

(72) Inventors: Yvon JULE, Marseille (FR); Florent TOMI, Marseille (FR); Jean-Claude GILHODES, Marseille (FR)

(73) Assignee: Biocellvia, Marseille (FR)

(21) Appl. No.: 17/256,143

(22) PCT Filed: Jun. 28, 2019
(86) PCT No.: PCT/FR2019/051615

§ 371 Date: Dec. 24, 2020

(30) Foreign Application Priority Data
Jun. 29, 2018 (FR) 1855954

(51) Int. Cl. G06T 7/00; G06T 7/60

(52) U.S. Cl. CPC G06T 7/0012; G06T 2207/30024; G06T 7/60

(57) ABSTRACT

The invention concerns a method for producing a multiparameter graphic indicator relating to a remodelling of human or animal pulmonary alveoli from a digital representation of a histological section of a lung comprising one or more components each of which describes a wall enclosing a lumen. The method can estimate one or more quantities of interest relating to one or more components in order to produce a graphic representation describing the quantity or quantities of interest in order to provide an aid for diagnosis of a disease or for analysis of the therapeutic effectiveness of molecules. The method is implemented by a processing unit of an electronic object of the histological analysis system.

The invention relates to a system and a method for producing a multiparameter graphic indicator with reference to the remodelling of the epithelium of a tissue of a human or animal organ, from an image of a histological section, and thus delivering an objective and reproducible aid to healthcare personnel so that they can establish a diagnosis with reference to a possible human or animal pathology. Indeed, such an aid to clinical diagnosis is becoming increasingly important, in particular with reference to the lung, since a pulmonary histological analysis is routinely used to confirm or rule out the suitability of a lung transplant. Furthermore, a system and a method according to the invention delivers an objective and reproducible aid to an investigator in the laboratory, so that they can estimate the curative relevance of a given treatment with respect to a pathology, and thus aid them in their analysis of the efficacy of a molecule from a treatment point of view.

Biological imaging is currently one of the major resources in exploration of the organs and the different organic tissues. In particular, it is predominantly involved in the fields of medical diagnosis support and preclinical and clinical research.

Different techniques are currently utilized in preclinical and clinical imaging, such as, non-limitatively, magnetic resonance imaging, optical, electronic and confocal microscopy, microtomography, ultrasound scanning, CT scanning. These techniques can be utilized for in vivo or ex vivo observations. The digital images thus obtained make it possible, in the context of institutional or industrial research laboratories, more particularly to analyze a biological state of organic tissues and to assess certain beneficial and/or toxic effects of certain substances with a view to the selection thereof for the development of future medicinal products.

In the era of digital transformation, the development of these digital imaging technologies has opened new perspectives for histological analysis overall.

The ability to access digital images of histological sections has made it possible to develop new methods based on descriptive and quantitative analysis of the digital images of said histological sections, by means of computerized tools utilizing innovative algorithms or innovative methods allowing an advance in terms of precision, reliability, speed and reproducibility.

However, utilization of the computerized tools that are currently available does not make it possible to automate the quantitative assessment of certain pathologies, such as, by way of non-limitative example, respiratory tract disorders. In fact, the investigator still remains only too present in the process of implementation of this assessment. Their manual in-person intervention leads to wide variabilities in characterization of the components of the samples of histological slides assessed.

In the context of aid in the diagnosis of certain pathologies affecting the respiratory tract, more particularly the small airways, such as for example rupture of the alveolar walls in patients who have developed emphysema, it can be advantageous to determine the morphology of the components characterizing said small airways. Indeed, it is currently difficult for healthcare personnel to determine the origin of a patient's symptoms, such as for example respiratory insufficiency, that are characteristic of a pulmonary tract disorder. Such a disorder may be caused by a large number of pathologies. In order to offer a suitable treatment to a patient presenting with a pulmonary tract disorder, it is crucial for healthcare personnel to determine the precise origin of such a disorder. In the context of pathologies affecting the small airways, it is often not at all easy for healthcare personnel to determine with certainty that these do in fact represent a disorder, and consequently to identify the pathological origin of such a disorder. By way of non-limitative example, emphysema is a pathology affecting the small airways, characterized mainly by destruction of the pulmonary alveoli which constitute the alveolar sacs. Generally, in order to characterize a case of emphysema, it is appropriate to observe under the optical microscope a histological section of a specimen taken from a patient's lung, so as to observe the presence or absence of such destruction. Emphysema is thus characterized by destruction of the alveolar walls and consequently an increase of the area of the alveoli within the alveolar sacs. Identification of these modifications of alveolar areas or alveolar spaces is therefore crucial in order to allow healthcare personnel to conclude that a patient is suffering from emphysema.

Currently, in order to determine if a patient is suffering from emphysema, the conventional assessment techniques essentially rely on the determination of a parameter “Lm” describing the distance separating two alveolar walls. Two known methods make it possible to estimate such an “Lm” parameter:
a first method called “mean linear intercept” consisting of assessing the number of points of intersection of an alveolar wall with a grid formed of vertical and horizontal rows of known dimensions, commonly known as “test rows”. In this method, the estimation of the “Lm” parameter represents a direct measurement of a mean free distance, i.e. an alveolar space between respective walls of the pulmonary alveoli analyzed on lung histological sections. The alveolar spaces commonly make it possible to characterize any ruptures of one or more alveolar walls which may occur in a large number of pathologies affecting the respiratory tract, such as emphysema;
a second method called “chord length” method, consisting of assessing a distance between points of intersection of alveolar walls with a test row, based on a grid similar to that defined for the first, “mean linear intercept” method. According to this second method, the parameter “Lm” describes a mean length of straight-line segments, commonly called “chords”, on test rows chosen at random by an investigator, and covering alveolar spaces between two sequential intersections of an alveolar surface with one of the test rows. It is important to note that the straight-line segments, or chords, may cross one or more alveoli situated on either side of an alveolar sac, indicating that the parameter “Lm” thus characterizes the acinar air space in its complex entirety and not only the alveoli. Said “Lm” parameter is therefore a value making it possible to estimate a volume-surface area ratio and can be defined by:

$$Lm = 4 \cdot ( \frac{V ( asp )}{S ( A )} )$$

where V(asp) corresponds to the volume of the alveolar spaces and of the alveolar sacs and S(A) consists of the area of the alveolar surface.

The application of such methods for the assessment of intersections raises a certain number of drawbacks. In fact, with respect to the avoidance of the effect of superposition of the alveoli, in particular due to performance of the histological section, estimation of the parameter “Lm” does not allow a direct measurement of the alveolar spaces. Indeed, this is instead a measurement of the whole of the acinar complex of the alveolar spaces and of the alveolar sacs combined, since in the grid test row, the entire internal complexity of the small airways is investigated.

The assessment techniques seen above are generally carried out with the aid of imaging microscopy techniques, based on several fields of observation of a histological slide covering only a restricted portion of the alveolar tissue of the analyzed pulmonary section. Thus, strong heterogeneity with respect to the distribution of abnormalities associated with a pathology will generally result in false interpretations with regard to establishing a diagnosis based on the few observed fields. In order to overcome these errors of interpretation, an investigator generally uses fields located at different positions of a pulmonary section, so as to limit the influence of the heterogeneity of the distribution of abnormalities associated with a pathology, in order to establish a diagnosis. In addition, the geometrical parameters of the grids used in assessment of said pathology are generally not standardized, and often vary from one laboratory to another.

Furthermore, although currently very widely used, the aforementioned measurement methods have a number of drawbacks. Firstly, they require a lengthy implementation time, i.e. sometimes several hours of hard work, and are dependent on the investigator who utilizes them. Thus generally they involve an additional analysis by a specialist pathologist in order to confirm or rule out the first results issued. Involvement of several investigators or specialist personnel thus results in a significant variability in the results with respect to the assessment of a pathology, and thus diagnoses that are sometimes random and/or contradictory.

Thus, the invention makes it possible to overcome all or part of the drawbacks raised above and makes it possible to provide invaluable aid to any investigator wishing to estimate quantities of interest with a view to producing a multiparameter graphic indicator in order to facilitate the establishment of a diagnosis with reference to a human or animal pathology, or to assess the relevance of a treatment with respect to said pathology.

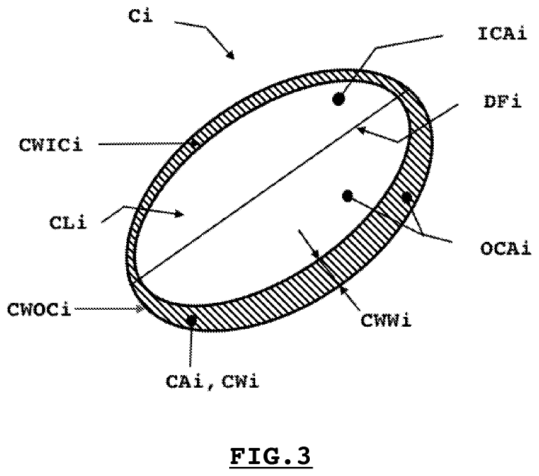

Certain pulmonary pathologies are characterized by destruction and remodelling of the pulmonary tissues, affecting the alveoli, bronchi, bronchioli and/or vessels. The invention allows a highly accurate quantitative morphometric analysis of the components observed in a histological section, making it possible to characterize, for example, destruction of such tissues. The invention thus makes it possible to deliver a multiparameter graphic indicator with reference to the morphology of tubular components of an organ, in particular the lungs, and more particularly the small respiratory airways. Thus the invention makes use of a digital representation, in the form of an array of a determined large number of pixels, of the order of several millions of pixels, of a histological section of said organ, describing a plurality of annular components resulting from the sectioning of said tubular components in order to perform a histological section. Said tubular components are evidenced by means of annular components in a two-dimensional representation, on completion of a histological section. The concept of tubular component will be described in greater detail hereinafter, with reference to FIG. 3.

Among the numerous advantages achieved by the invention, there may be mentioned that it makes it possible to:
reduce considerably the analysis time necessary for establishing a diagnosis of a pathology by an investigator, reducing said time to less than one minute according to the processing power of the device or of the electronic system implementing a method according to the invention;
increase the accuracy and reliability of the measurements of an analyzed sample by taking account of the entirety, or at least a very large number, of pixels of interest from the digital representation of a histological section;
overcome the variability of results between different investigators, delivering objective and reproducible results.

To this end, the invention relates to a method for producing a multiparameter graphic indicator relative to a remodelling of human or animal alveolar epithelium, based on a digital representation of a histological section of a pulmonary lobe. Such a digital representation consists of a matrix or array of a determined number of pixels, these latter describing one or more components having annular shape, within the parenchyma of said lobe, wherein each of said one or more components has a wall encircling a lumen, the method being implemented by a processing unit of a system for histological analysis, said system moreover comprising an output human-machine interface and a data memory.

In order to be able to produce a multiparameter graphic indicator, said method comprises:
a step for estimating, from pixels of said digital representation, a quantity of interest relative to the morphology of a component present in the histological section, said quantity of interest belonging to a set of quantities of interest comprising:
   i. the Feret diameter of the outer contour of the wall of a component;
   ii. a mean distance separating said outer contour from the inner contour, describing a mean thickness of the wall of a component;
   iii. the area described by said inner contour of a component, describing the area of the lumen thereof;
   iv. the area described by said outer contour of a component, describing the total area covered thereby;
a step for estimating a quantity of interest relative to the structure of the parenchyma of the lobe, said quantity of interest belonging to a set of quantities of interest comprising:
   i. a lobe density, corresponding to a ratio between a number of identified components and the area of the lobe;
   ii. a void rate, corresponding to a ratio between the sum of the areas of the respective lumina of the identified components and the area of the lobe;
   iii. a parenchyma rate, corresponding to the area described by the parenchyma with respect to the area of the lobe;
a step for producing, per estimated quantity of interest, a graphic representation thereof relative to a standard quantity of interest;
a step for producing the joint graphic rendering of the graphic representations of said quantities of interest relative to the respective standard quantities of interest and produced beforehand, by the output human-machine interface of the system.

Advantageously, the step for estimating respective quantities of interest relative to the morphology of one or more components and/or to the structure of the parenchyma of the lobe can comprise a subsequent step for registering, in the data memory, a data structure associated with each component and/or with the lobe, said data structure comprising a field for storing the value of each estimated quantity of interest.

In a variant or in addition, in order to produce a multiparameter graphic indicator relative to one or more quantities of interest of one or more types of components, a method according to the invention can comprise a step for characterizing a type of component based on the value of one of the estimated quantities of interest. The step for registering, in the data memory, a data structure associated with each estimated quantity of interest of a component, consists of registering in a field of said data structure a value characterizing a determined type of component.

Preferentially, but non-limitatively, in order to facilitate the typing of the components present in a digital representation of a histological section, a method according to the invention, for which, when one of the estimated quantities of interest consists of the Feret diameter of the outer contour of the wall of the component, the step for characterizing a type of component can comprise an operation of comparison of the value of said estimated Feret diameter to a high-diameter threshold and/or a low-diameter threshold.

In a variant or in addition, in order to facilitate the typing of the components present in a digital representation of a histological section, the method, for which, when one of the estimated quantities of interest consists of the mean thickness of the wall of the component, the step for characterizing a type of component can comprise an operation of comparison of the value of said mean thickness to a predetermined high-thickness threshold and/or low-thickness threshold.

In order to provide an investigator with information relative to the morphology of one or more components of interest, it is possible for the step for producing, per estimated quantity of interest, a graphic representation thereof relative to a standard quantity of interest and/or the step for causing the joint graphic outputting of the graphic representations of said quantities of interest relative to the standard quantities of interest to be implemented for a determined characterized type of component only.

Advantageously, in order to allow an investigator to identify a remodelling of the alveolar epithelium such as thinning or total or partial destruction thereof, or any other modification of the morphology of the small airways, the type of characterized component determined by a method according to the invention can be an alveolus and/or an alveolar sac.

Preferentially but non-limitatively, in order to provide an investigator with a visual aid making it possible instantly to compare estimated quantities of interest revealing a possible change of morphology of the components and/or of the structure of the parenchyma of the lobe of a lung wherein said estimated quantities of interest originated, with a view to directing the diagnosis of a pathology, the step for causing the joint graphic outputting of the graphic representations of said quantities of interest relative to the respective standard quantities of interest, produced beforehand by the output human-machine interface of the system, can consist of the display by the latter of a radar chart, showing at least three graphic representations of quantities of interest relative to the respective standard quantities of interest on normed axes.

In a variant or in addition, in order to provide an investigator with a visual aid making it possible instantly to compare estimated quantities of interest revealing a possible change of morphology of the components and/or the structure of the parenchyma of the lobe of a lung from which said estimated quantities of interest originated, with a view to directing the diagnosis of a pathology, the step for causing the joint graphic outputting of the graphic representations of said quantities of interest relative to the respective standard quantities of interest produced beforehand by the output human-machine interface of the system, can consist of the display by the latter of a bar chart, showing the graphic representations of quantities of interest relative to the respective standard quantities of interest by normalized bars.

So as to output to an investigator a multiparameter graphic indicator having quantities of interest at one and the same scale and thus provide an instant visual aid, a step of a method according to the invention can consist of normalizing an axis or a bar, expressing the value of an estimated quantity of interest as a percentage of the value of the associated standard quantity of interest.

In order to allow an investigator instantly to visualize a significant difference between estimated quantities of interest and standard quantities of interest that are very similar, a step of a method according to the invention can consist of normalizing an axis or a bar, expressing the value of an estimated quantity of interest relative to the value of the associated standard quantity of interest in the form of three predetermined values respectively describing values of the estimated quantity of interest that are substantially lower than, similar to, or greater than the values of the associated standard quantities of interest.

According to a second subject, the invention relates to an electronic object of a system for histological analysis, said electronic object comprising a processing unit and cooperating with an output human-machine interface and with a data memory, said data memory comprising:
a digital representation of a histological section of a human or animal organ;
instructions that can be executed or interpreted by the processing unit, wherein the interpretation or execution of said instructions by said processing unit causes the implementation of a method according to the invention.

According to a third subject, the invention relates to a system for histological analysis comprising an electronic object according to the invention and an output human-machine interface suitable for outputting to a user a multiparameter graphic indicator according to a method according to the invention and implemented by said electronic object.

According to a fourth subject, the invention relates to a computer program product comprising one or more instructions that can be interpreted or executed by a processing unit of an electronic object according to the invention, the interpretation or execution of said instructions by said processing unit causing the implementation of a method according to the invention.

Other characteristics and advantages will become clearer on reading the following description and on examining the figures accompanying it, in which:

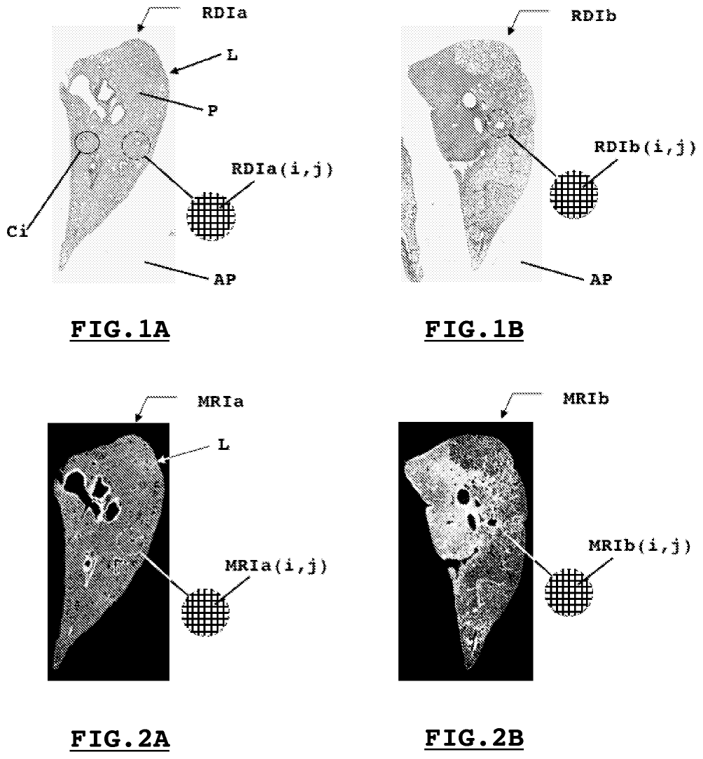

FIGS. 1A and 1B respectively present first digital representations, in the form of pixel arrays, of two histological sections of a lung, more specifically of a lobe of said lung, respectively from a first, healthy patient and from a second patient suffering from emphysema, said first and second patients studied being in this case mice;

FIGS. 2A and 2B show second binary digital representations, in the form of pixel arrays, originating respectively from those presented in FIGS. 1A and 1B, said second binary digital representations highlighting pixels of interest with respect to other pixels;

FIG. 3 shows diagrammatically a section of a tubular component of the parenchyma of a lobe of a lung, from which are estimated quantities of interest relative to the morphology of an annular component resulting from said section of such a tubular component;

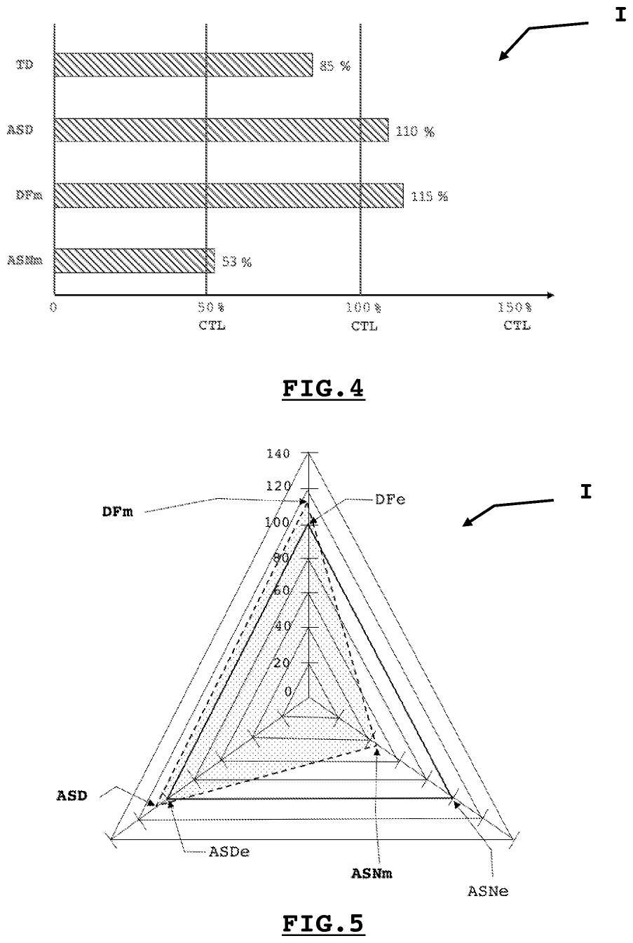

FIG. 4 presents a first example of graphic representation, in the form of a bar chart, of a multiparameter graphic indicator produced by a method according to the invention, said indicator describing a plurality of estimated quantities of interest relative to a plurality of respective standard quantities of interest on normed axes, in a patient suffering from emphysema;

FIG. 5 presents a second example of graphic representation, in the form of a radar chart, of a multiparameter graphic indicator produced by a method according to the invention, said indicator showing a plurality of estimated quantities of interest relative to a plurality of respective standard quantities of interest on normed axes, in a patient suffering from emphysema;

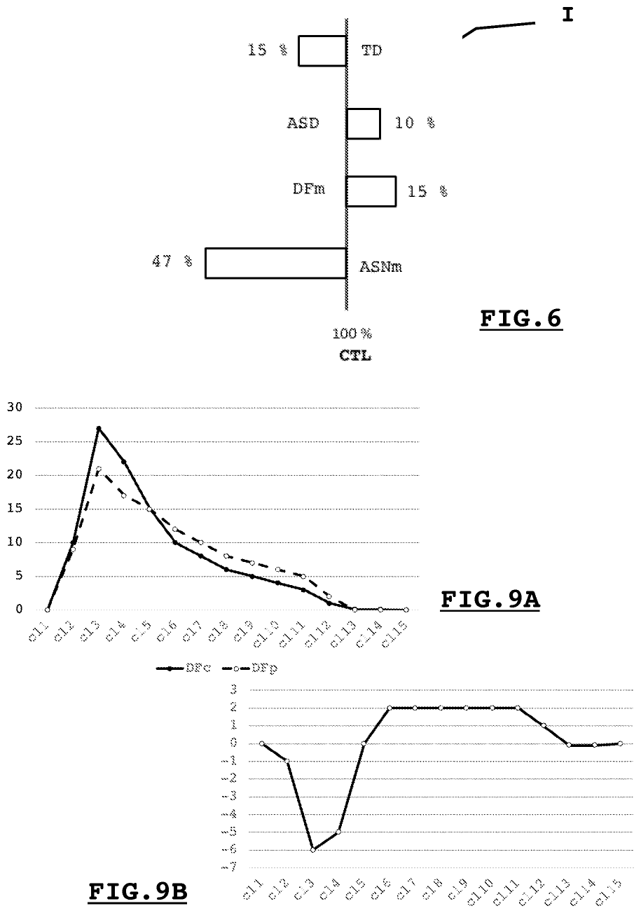

FIG. 6 presents a third example of graphic representation, in the form of a bar chart, of a multiparameter graphic indicator produced by a method according to the invention, said indicator describing a plurality of estimated quantities of interest relative to a plurality of respective standard quantities of interest on normed axes, in a patient suffering from emphysema;

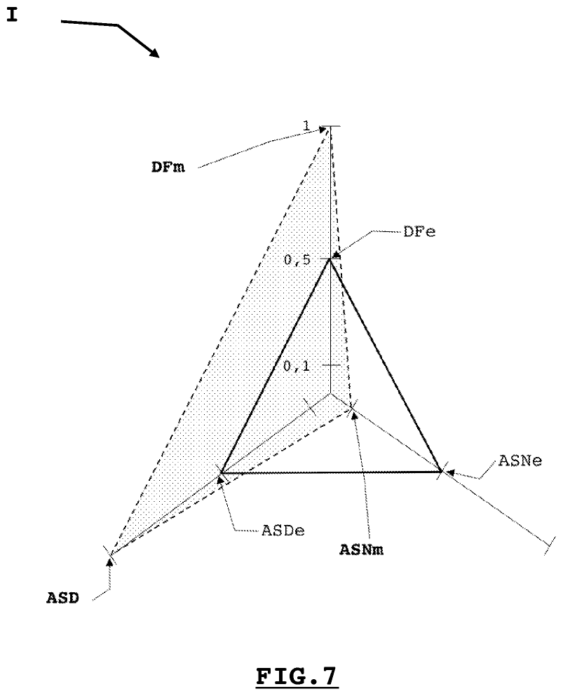

FIG. 7 presents a fourth example of graphic representation, in the form of a radar chart, of a multiparameter graphic indicator produced by a method according to the invention, said indicator showing a plurality of estimated quantities of interest relative to a plurality of respective standard quantities of interest on normed axes, in a patient suffering from emphysema;

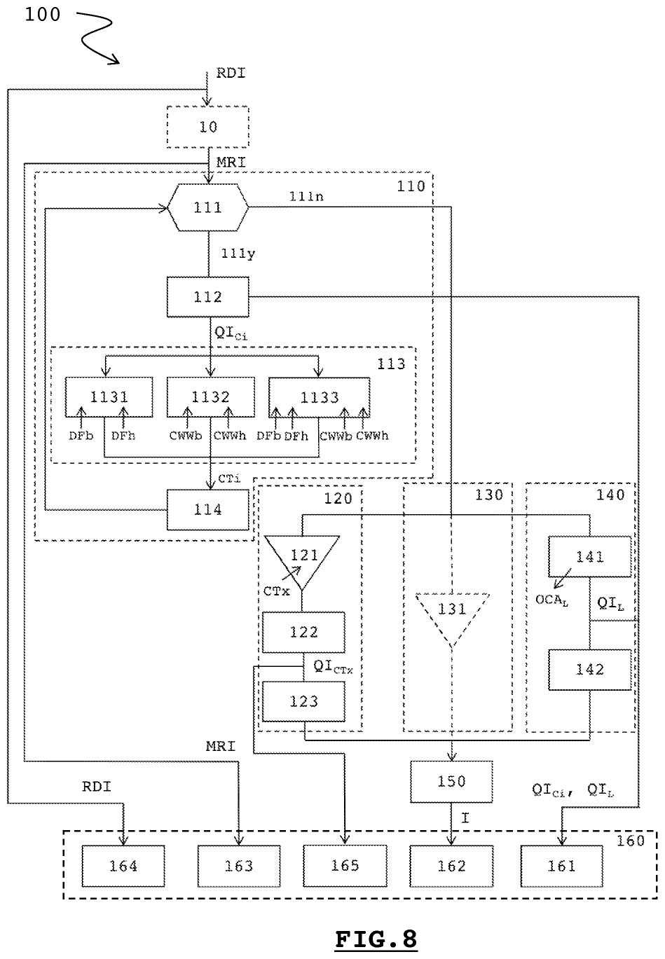

FIG. 8 presents a simplified flow chart showing a non-limitative example of a method for producing a multiparameter graphic indicator relative to a tissue of a human or animal organ according to the invention;

FIGS. 9A and 9B show graphic representations complementary to a multiparameter graphic indicator.

FIG. 1A shows a first digital representation RDIa of a histological section of a lung of a healthy patient, in this case a mouse. FIG. 1B shows a first digital representation RDIb of a histological section from a patient, in this case a mouse, suffering for example from emphysema. A quick comparison of these first digital representations RDIa and RDIb makes it possible to observe that they have significant differences. Such first digital representations RDIa, RDIb generally originate from a process of scanning a histological section. A digitized histological section with ×20 enlargement delivers a digital representation RDI in a matrix form with approximately two hundred million pixels, i.e. according to the examples in FIGS. 1A and 1B, digital representations RDIa and RDIb in the form of arrays of fifteen thousand rows on the same number of columns, each element or pixel RDI(i,j) of said array, i and j being two values respectively describing the i^{th} row and the j^{th} column of said array RDI, encoding a triplet of integer values comprised between zero and two hundred and fifty-five, according to the RGB (red green blue) colour model. Such a computerized colour model is the most used by the available material. In general, computer screens reconstitute a colour by additive mixing from three primary colours, a red, a green and a blue, forming on the screen a mosaic that is generally too small to be distinguished by humans. The RGB model gives a value for each of these primary colours. Such a value is generally coded on one byte and thus belongs to an integer value interval comprised between zero and two hundred and fifty-five.

The RDIa and/or RDIb representations present, in a distinguishable manner in the centre of said representation, the lobe L of a lung. Such an organ, more specifically the parenchyma thereof, comprises numerous substantially tubular components Ci, wherein the inner walls respectively form lumina. Following the sectioning carried out to produce a histological section subsequently digitized and performed at the level of the pulmonary lobe, only sections of said tubular components Ci are visible, in two dimensions on the representation RDI resulting from said digitization of the histological section. Such a component Ci can be described, in particular with reference to FIG. 3, as an annular structure, wherein the ring is a section of the wall of said component Ci, encircling a hole associated with a lumen. Such tubular components Ci consist mainly of vasculature, bronchi, bronchioli or alveoli forming alveolar sacs. The remainder of the tissue P of said lobe is hereinafter called “parenchyma”. A component of interest Ci, for example a pulmonary alveolus, thus has an annular shape shown in FIG. 3. Said alveolus Ci, and more generally an annular component Ci, comprises an outer contour CWOCi, an inner contour CWICi encircling a lumen CLi, said inner and outer contours delimiting a wall CWi, wherein the corresponding areas are denoted by a blunt arrow with reference to FIG. 3.

When a patient is suffering for example from an obstructive respiratory disease, the lesion of the lung is revealed by changes in the morphology of some of the tubular components forming the lung, in particular by a remodelling of the airways, or destruction of all or part thereof, in particular the alveoli, in the case of emphysema. The diameter of the alveoli is generally comprised, within the taxonomy of the vertebrates, between one hundred microns and two hundred and fifty microns. Emphysema thus involves, in an early disorder of the airways of a patient, thinning of the alveolar wall, characterized on a digital representation of a histological section of a lung by a ring representing a section of such an alveolar wall. Such a thinning of an alveolar wall, the latter being already very thin in a healthy patient, i.e. of the order of one micrometre, can result in a rupture of said alveolar wall, directly impacting the area of the alveolar space. In fact, the alveoli generally form the last link in the chain of the respiratory tract and allow gaseous interchange with the blood. Said alveoli generally form clusters, more commonly called “alveolar sacs”, each alveolar sac comprising a plurality of pulmonary alveoli. Thus, an emphysema disorder generally results in rupture of the alveolar walls, characterized by an increase of the area of the alveolar spaces. By alveolar space, also known as “airspaces”, is meant a lumen enclosed by an inner wall of an alveolus. Thus, the mean area of the alveolar spaces or lumina, as well as the density of the alveolar spaces or lumina increase, while the number of alveolar spaces or lumina reduces within the parenchyma. Such a disorder is characterized, on a digital representation of a histological section of a lobe of a lung, by an increase of pixels describing areas of annular structures, i.e. areas of sections of tubular components, and more particularly areas encircled by rings, i.e. areas of transverse sections of lumina of tubular components. Thus FIG. 1B shows a first digital representation RDIb, similar to the first digital representation RDIa presented with reference to FIG. 1A, wherein the pixels RDIb(i,j) describe a lobe L of a lung of a patient suffering from emphysema.

The histological sections wherein result, for example, a digital representation RDI, such as representations RDIa and RDIb shown respectively by FIGS. 1A and 1B, according to the state of the art are difficult for investigators to use in order to determine the presence of morphometric modifications resulting from a possible destruction of the small airways, characterizing a pathology such as emphysema. In fact, said morphometric modifications, more particularly the destruction of all or part of the alveolar walls of the small alveoli constituting a lung, are difficult for an investigator to identify from a histological section. In fact, the destruction of the alveolar walls, in particular the small alveoli forming an alveolar sac is such that said small alveoli affected may easily be mistaken during observation by an investigator of a histological section of a lung, for healthy alveoli of equivalent sizes, which greatly complicates establishing a diagnosis of emphysema disorder in the respiratory tract. Thus, according to the state of the art, the aforementioned techniques are preferred for characterizing, in patients, affected small pulmonary alveoli, in particular in the case of emphysema resulting from pollution due to fine particles or to ozone, in which the small alveoli are the most affected.

In order to produce an objective, automated and almost real-time aid to such investigators, the invention envisages focusing on the morphometric properties of the components identified in a histological section of a lung by using a digital representation RDI of said histological section, obtained by digitization thereof.

In order to facilitate finding or identifying components of interest Ci within a digital representation RDI, a method for producing a multiparameter graphic indicator according to the invention can comprise a prior step, consisting of processing to binarize said first digital representation RDI, such as the representations RDIa and RDIb, and to produce a second digital representation MRI, such as the binary digital representations MRIa and MRIb shown respectively in FIGS. 2A and 2B. Such a second digital representation MRI can be produced by any known type of digital processing intended to binarize a digital representation RDI in colour(s), such as the digital representation RDIa or RDIb. Such a digital representation or binary image MRI is revealed in the form of an array comprising one and the same number of elements or pixels MRI(i,j) as the first digital representation RDI of a histological section wherein it originates, such as the first digital representation RDIa or RDIb mentioned above with reference to FIGS. 1a and 1b. Said second digital representation MRIa or MRIb is called binary because each of the elements thereof MRI(i,j), denoted by two indices i and j respectively determining the row and the column of said element or pixel in the array MRI, comprises an integer value chosen from two predetermined values respectively signifying that the pixel RDI(i,j), i.e. of one and the same column j and one and the same row i in a first digital representation RDI, denotes a portion of the lobe L or not.

By way of non-limitative example, FIGS. 2A and 2B show two examples of second binary representations MRI, the second binary digital representations MRIa and MRIb in this case respectively originating from the first digital representations RDIa and RDIb shown with reference to FIGS. 1A and 1B. According to these examples, an element MRIa(i,j) or MRIb(i,j) of the array MRIa or MRIb adopts the value zero if the associated pixel RDIa(i,j) or RDIb(i,j), i.e. denoted by the row i and the column j, in the first digital representation RDIa or RDIb is not a pixel of interest, i.e. said pixel describes either a lumen formed by the transverse section of a tubular component, or the exterior of the lobe L of the lung. In the alternative, on the other hand, such an element MRIa(i,j) or MRIb(i,j) adopts the value two hundred and fifty-five. In this way, such a second binary digital representation MRI can be displayed in black and white on a computer screen. In a variant, predetermined values could have been chosen other than the values zero and two hundred and fifty-five to characterize the absence of interest or the interest of such a pixel.

Advantageously but non-limitatively, processing 10 for producing a binary representation MRI of a digital representation RDI can be implemented beforehand to facilitate the estimation of quantities of interest relative to annular components identified in a digital representation of a histological section of a tissue of a human or animal organ, and ultimately the production of a multiparameter graphic indicator, according to a method 100, wherein a non-limitative example embodiment is in particular described with reference to FIG. 8. For the sake of brevity and simplicity, reference will be made to morphology of a component Ci instead of the morphology of the section of annular shape of a tubular component Ci, as described with reference to FIG. 3. Thus, by application of the histological section, a tubular component of interest Ci is revealed in a digital representation RDI or MRI by a two-dimensional annular structure. A non-limitative example of processing 10 intended to binarize such a first digital representation RDI, such as the digital representations RDIa, RDIb, can comprise a first step for producing a first intermediate digital representation in greyscale, not shown in FIG. 8 for the sake of simplicity. Said intermediate digital representation comprises one and the same number of elements or of pixels as the first digital representation RDI. Such a first step can consist of the implementation of any known technique for converting, for each pixel of the representation RDI, the triplet of values representing the primary colour scales to an integer value representing a colour value or luminous intensity associated with a greyscale pixel of the intermediate digital representation thus produced. Said first step can moreover consist of the application, on the thus-produced greyscale intermediate digital representation, of a median or bilateral filter to suppress certain anomalies.

A second step of such processing 10 intended to binarize a digital representation RDI can consist of implementing automatic thresholding of the pixels of the greyscale intermediate digital representation, so as to distinguish the pixels describing all or part of a lumen formed by the transverse section of a tubular component or the exterior of the lobe L of the lung. The pixels associated with a lumen or with the exterior of the lobe adopt the value zero, thus appearing in black in FIGS. 2A and 2B. The other pixels adopt the value two hundred and fifty-five and appear in white. These latter are associated with the parenchyma of the lobe, more particularly with certain components comprised within the parenchyma, such as vasculature, alveoli, alveolar sacs, bronchi or bronchioli. This second step thus produces a second binary digital representation MRI.

Such processing 10 intended to binarize a digital representation can, in addition, produce a third binary digital representation, which will be called “Lobe mask”, having the same dimensions as the second binary digital representation MRI, wherein each element comprises a first value specifying that an associated pixel within a digital representation RDI or MRI belongs to the lobe or is exterior thereto. In fact, taking account in particular in the second binary digital representation MRI of pixels associated with the background AP of the lobe L can affect the relevance of the quantities of interest produced and ultimately the relevance of a multiparameter graphic indicator produced by a method according to the invention. To this end, in a non-limitative example of a method according to the invention, a pixel from the second binary digital representation MRI will only be taken into consideration if, and only if, the associated pixel in said lobe mask, i.e. having the same row and column indices, comprises a value characterizing a pixel belonging to the examined lobe L. Such a third digital representation, not shown in the Figures, can be produced in addition to the second step of processing 10 intended to binarize a digital representation RDI, by finding the greatest contour by implementing, for example, a “flood-fill” algorithm.

FIG. 8 shows a non-limitative example embodiment of a method 100 according to the invention for producing a multiparameter graphic indicator I relative to remodelling of the epithelium of a human or animal organ, based on using the pixels of a digital representation of a histological section of said organ, whether such a representation is in the form of a colour RDI or binary MRI digital representation.

Such a method 100 and/or such prior processing 10 intended to binarize a digital representation RDI and produce a digital representation MRI can be arranged to be transcribed into a computer program, wherein the program instructions can be installed in a program memory of an electronic object, in the form for example of a computer having sufficient processing power and/or suitable for the analysis of digital representations or images of concomitant sizes, taking account of the accuracy necessary for analysis of a pulmonary lobe L.

Said program instructions are thus arranged to produce the implementation of said method 100 and/or prior processing 10 intended to binarize a digital representation RDI by the processing unit of such an electronic object. Within the meaning of the present document, by “processing unit” is meant one or more microcontrollers or microprocessors cooperating with a program memory hosting the computer program according to the invention. Such a processing unit can moreover be arranged to cooperate with a data memory to host, i.e. store, the digital representations produced by the implementation of a method 100 to produce a multiparameter graphic indicator I relative to a remodelling, more particularly total or partial destruction of the alveolar epithelium, according to the invention, and/or all other data necessary for the implementation thereof.

Such a processing unit can also be arranged to cooperate with an output human/machine or peripheral interface, such as a computer screen, a printer or any other interface for delivering the content of said multiparameter graphic indicator I to a human being, so as to be perceived by means of one of the senses.

Firstly, such a method 100 for producing a multiparameter graphic indicator I, described with reference to FIG. 8, can comprise a step 110, optionally iterative, of steps intended to find one or more components Ci from a first digital representation RDI and/or MRI of a histological section of a tissue of a human or animal organ.

Said iterative sequence of steps 110 of a method for producing a multiparameter graphic indicator I according to the invention comprises a step 112 for estimating one or more quantities of interest QI relative to the respective morphologies of said components Ci present in the histological section and described by the pixels of a digital representation RDI and/or MRI of said histological section. At the end of such an iteration, i.e. when all the components Ci have been identified in a first digital representation RDI and/or MRI of a histological section of a tissue of a human or animal organ, a method 100 according to the invention can comprise a sequence of steps 140 capable in particular of comprising a step 141 for estimating a quantity of interest QI_{L} relative to the structure of the parenchyma of the lobe. Such a quantity of interest can correspond to a density of the lobe, a void rate of the lobe or a parenchyma rate.

In all cases, a sequence of steps 140 and/or a step 141 for estimating a quantity of interest QI_{L} can respectively comprise and/or be followed by a step for registering, in the data memory 142, a data structure associated with each identified component Ci and/or with the structure of the parenchyma of the lobe, and storing different values for quantities of interest with reference to the morphology of said components Ci and/or to said structure of the parenchyma of the lobe.

A method 100 implemented by an electronic object of a system for histological analysis according to the invention will now be described in greater detail.

As specified above, such a method 100 can advantageously comprise an iterative sequence of steps 110 comprising a step 111 consisting of “finding” i.e. by analyzing the respective contents or values of the pixels of a digital representation RDI and/or MRI of a histological section, the pixels describing a first lumen described by the section of a component Ci, i.e. consequently, the inner contour of the wall of said identified component Ci. By the application of a technique such as described by Satochi Suzuki et al. “Topological structural analysis of digitized binary images by border following”, Computer Vision, Graphics, and Image processing, 1985, or any other equivalent technique, step 111 consists of determining, from digital representations RDI and/or MRI, topologies of substantially annular components Ci present in said digital representation RDI and/or MRI. It is then possible to determine the contour of an area associated with a lumen of a component Ci, the latter resembling on a binary digital representation MRI a set of contiguous pixels describing for example a number of values equal to zero. The result of the application of such a technique is revealed by a first polyline wherein the indices, i.e. the columns and rows of the pixels constituting the characteristic points therein, describe said contour of the inner wall, delimiting the lumen identified beforehand of a component Ci. Step 111 currently consists of determining, from such a first polyline, the contour of the outer wall of the identified component Ci. By way of non-limitative example, such a step 111 of such a method 100 can implement a technique called “morphological dilation of the inner contour” described in the work by Jean Serra, Image Analysis and Mathematical Morphology, 1982, or any other equivalent technique. Utilization of such a technique thus produces a second polyline wherein the indices, i.e. the columns and rows of the pixels constituting the characteristic points therein, make it possible, together with the first polyline produced beforehand, to estimate the morphology of a component Ci, defined by the first and second thus-determined polylines. Thus, by application of the histological section, a component of interest Ci is revealed, in a digital representation RDI or MRI, by a two-dimensional annular structure.

From said first and second polylines, an iterative sequence of steps 110 of a method 100 for producing a multiparameter graphic indicator I according to the invention comprises a step 112 consisting of estimating one or more quantities of interest QI_{Ci} relative to said morphology of said component Ci wherein the lumen was identified beforehand.

As specified above, different quantities of interest QI_{Ci} can be estimated in step 112 of a method according to the invention. As shown in FIG. 3, such quantities of interest may non-limitatively consist of:
the Feret diameter DFi of a component Ci identified beforehand. Within the meaning of the invention and throughout the document, by “Feret diameter” is meant the greatest distance between two tangents to the second polyline describing the apparent outer contour CWOCi of the wall CWi of said component Ci, said tangents being parallel to one another and perpendicular to a given direction vector. By varying the polar angle of said vector from 0 to 2π, during the implementation of step 112, a set of diameters can thus be estimated, wherein the largest corresponds to the Feret diameter DFi retained for characterizing said component Ci;
the mean distance CWWi, also called mean thickness CWWi, of the wall CWi of a component Ci identified beforehand. Within the meaning of the invention and throughout the document, by “mean thickness CWWi” is meant the ratio between the sum of the estimated distances separating the outer contour CWOCi from the inner contour CWICi of said component Ci identified beforehand and the number of estimated distances. In the context of pathologies affecting the small airways, such as emphysema, the wall CWi of certain components Ci found in the lungs may suffer thinning, or even total or partial destruction;
the area ICAi described by the inner contour CWICi of the wall CWi of a component Ci, describing the lumen CLi thereof. By “area ICAi” is meant the area of a section describing the lumen CLi of a component Ci, said area being delimited by the first polyline of said component Ci;
the area OCAi described by the outer contour CWOCi of a component Ci, describing the total area covered thereby. Within the meaning of the invention and throughout the document, by “area OCAi” is meant the total area describing the lumen CLi and the wall CWi of a component Ci, said area OCAi being delimited by the second polyline of said component Ci;
the area CAi described by the wall CWi of a component Ci, describing the area covered thereby. Within the meaning of the invention and throughout the document, by “area CAi” is meant the area describing the wall CWi, said wall CWi being delimited by the first and second polylines associated respectively with the inner contour CWICi and the outer contour CWOCi of said component Ci.

By way of advantageous but non-limitative example, implementation of step 112 of a method 100 for producing a multiparameter graphic indicator I according to the invention makes it possible, from first and second polylines produced beforehand, respectively associated with the inner contour CWICi and the outer contour CWOCi, to estimate one or more quantities of interest QI, such as, non-limitatively, the Feret diameter DFi of a component Ci. A non-limitative example of such a step 112 for estimating such a diameter DFi consists of adding the pixels of known dimensions, in order to deduce therefrom a corresponding distance characterizing said diameter. The relative distance at each diameter can thus be estimated, and the greatest distance corresponding to the Feret diameter DFi may thus be recorded, during the implementation of a step 114 of a method 100 for producing a multiparameter graphic indicator I according to the invention, in a data structure associated with the component Ci.

Step 112 of a method 100 for producing a multiparameter graphic indicator I according to the invention can, in a variant or in addition, consist of estimating a mean thickness CWWi of the wall CWi of a component Ci identified beforehand. An example of such a step 112 for estimating such a mean thickness CWWi can consist of estimating, for each pair of pixels of a first and a second polyline respectively describing the inner contour CWICi and the outer contour CWOCi of the wall CWi of said component Ci, the smallest distance, in number of pixels, separating said pixels of a pair. A plurality of estimations of distances describing the thickness of the wall CWi of the corresponding component Ci can thus be estimated, so that by averaging said estimations, the implementation of such a step 112 makes it possible to estimate a mean thickness CWWi of the wall CWi of said component Ci. Said mean thickness CWWi may also be recorded during the implementation of a step 114 of a method 100 for producing a multiparameter graphic indicator I according to the invention, in a data structure associated with the component Ci.

Step 112 of a method 100 for producing a multiparameter graphic indicator I according to the invention can, in a variant or in addition, consist of estimating an area ICAi describing the area of the lumen CLi of a component Ci identified beforehand. An example of such a step 112 for estimating such an area ICAi can consist of adding the pixels having known dimensions captured by said first polyline. A second non-limitative example of implementation of a step 112 for estimating an area ICAi of a lumen CLi can consist of multiplying the area of a pixel by the number of pixels encircled or captured by said first polyline associated with the inner contour CWICi of said component Ci. Said area ICAi of the lumen CLi may also be recorded during the implementation of a step 114 of a method 100 for producing a multiparameter graphic indicator I according to the invention, in a data structure associated with the component Ci.

Step 112 of a method 100 for producing a multiparameter graphic indicator I according to the invention can moreover consist of estimating an area OCAi describing the surface area of a component Ci identified beforehand. An example of such a step 112 for estimating such an area OCAi can consist of adding the pixels having known dimensions describing the surface area delimited by said second polyline. Implementation of such a step 112 makes it possible to estimate the area OCAi, corresponding to the sum of the areas of the pixels describing the totality of the area of the component Ci identified beforehand. Said area OCAi may be recorded during the implementation of a step 114 of a method 100 for producing a multiparameter graphic indicator I according to the invention, in a data structure associated with the component Ci.

Advantageously but non-limitatively, the step 112 of a method 100 for producing a multiparameter graphic indicator I according to the invention can also consist of estimating an area CAi describing the area of the wall CWi of a component Ci identified beforehand. An example of such a step 112 for estimating such an area CAi can consist of subtracting the area ICAi, described by the inner contour CWICi of a component Ci, from the area OCAi, described by the outer contour CWOCi of the same component Ci, said areas ICAi and OCAi being estimated beforehand. Said area CAi may be recorded during the implementation of a step 114 of a method 100 for producing a multiparameter graphic indicator I according to the invention, in a data structure associated with the component Ci.

In order to deliver an aid to diagnosis of a pulmonary pathology or in the analysis of the therapeutic efficacy of a molecule for an investigator, in particular so that they can focus only on certain components Ci determined or considered to be of interest, a method 100 according to the invention can comprise a step 113 for characterizing a type of component Ci from the value of one of the quantities of interest estimated beforehand during step 112. By way of non-limitative example, types of components identifiable in a digital representation RDI, MRI of a histological section can correspond to an alveolus and/or an alveolar sac, a bronchiolus, a bronchus and a vessel. In fact, as said types of tubular components mentioned above have annular bodies of very different morphologies, it may be advantageous to type each identified component Ci in order to be able to determine as accurately as possible if said components Ci have morphological modifications, as is often the case with pathologies affecting the pulmonary tract.

According to a non-limitative embodiment example described with reference to FIG. 8, a step 113 for characterizing a type of component Ci of a method 100 according to the invention can consist of comparing, in a sub-step 1131, the value of the Feret diameter DFi of a component Ci estimated during step 112 to a high-diameter threshold DFh and/or a low-diameter threshold DFb, said thresholds DFh and DFb advantageously being capable of being parameterized beforehand. Thus, in order to characterize for example a component Ci of the pulmonary alveolus type, said sub-step 1131 may consist of assigning a predetermined value, for example the value “1” to a dedicated field in the data structure associated with said component Ci, if the Feret diameter DFi thereof is less than a low-diameter threshold DFb of one hundred micrometres. In fact, the types CTi of components Ci observed in a histological section of a lung generally have a diameter substantially comprised between ten micrometres and one thousand micrometres. Use of the Feret diameter proves particularly advantageous, since such a use thus facilitates the classification of the different types CTi of components Ci and allows an investigator to only take into consideration one or more types of components of interest from the different types CTi of identified components Ci, in order subsequently to produce a multiparameter graphic indicator I providing a valuable aid in the establishment of a diagnosis of a pathology affecting the respiratory tract or an analysis of the therapeutic efficacy of a molecule.

In a variant or in addition, still with reference to FIG. 8, a step 113 for characterizing a type CTi of component Ci of a method 100 for producing a multiparameter graphic indicator I according to the invention can consist of comparing, in a sub-step 1132, the value of the mean thickness CWWi of a component Ci estimated during step 112, to a high mean-thickness threshold CWWh and/or a low mean-thickness threshold CWWb, said thresholds CWWh and CWWb advantageously being capable of being parameterized beforehand. Thus, in order to characterize a component Ci of the pulmonary alveolus type, said sub-step 1132 may consist of assigning said predetermined value “1” in a dedicated field in the data structure associated with said component Ci, if the mean thickness CWWi thereof is less than a high-thickness threshold CWWh of ten micrometres, advantageously less than a high-thickness threshold CWWh of five micrometres, preferentially less than a high-thickness threshold CWWh of two micrometres. In fact, the types CTi of components Ci found in a histological section of a lung generally have a mean thickness CWWi greater than ten micrometres. Only certain components Ci have a mean thickness CWWi less than ten micrometres, such as the components Ci of the alveolus and alveolar sac type. Use of the mean thickness CWWi of the wall CWi can facilitate the classification of the different types CTi of components Ci and allow an investigator to only take into consideration the type or types CTi of the components Ci of interest, in order subsequently to produce a multiparameter graphic indicator I providing a valuable aid in the establishment of a diagnosis of a pathology affecting the respiratory tract.

Two examples of characterization of types CTi of components Ci have been described above, in particular from an estimated quantity of interest. However, in certain cases, use of a single quantity of interest is not sufficient to distinguish certain types CTi of components Ci, for example the alveoli and bronchioli. In order to overcome this drawback, the invention provides that the step 113 for characterizing a type CTi of component Ci of a method 100 for producing a multiparameter graphic indicator I according to the invention may be arranged to use at least two different quantities of interest together. According to an embodiment of such a method 100 described with reference to FIG. 8, said step 113 can firstly consist of comparing, in a sub-step 1133, the value of the Feret diameter DFi of a component Ci estimated during step 112 to a high-diameter threshold DFh and/or a low-diameter threshold DFb, said thresholds DFh and DFb advantageously being capable of being parameterized beforehand. If said value of the Feret diameter DFi of a component Ci is comprised between said thresholds DFb and DFh, then such a sub-step 1133 will also consist of comparing the value of the mean thickness CWWi of said component Ci estimated in step 112 to a high mean-thickness threshold CWWh of ten micrometres, advantageously to a high mean-thickness threshold CWWh of five micrometres, preferentially to a high mean-thickness threshold CWWh of two micrometres. In fact, in the context of airways affected by a pathology such as emphysema, it is known that the pulmonary alveoli suffer from total or partial destruction, being characterized by a rupture of the alveolar wall. Thus, it becomes difficult to identify such alveoli and to estimate the morphology thereof. On the other hand, it is always possible to identify the components Ci of the alveolar sac type, since in the context of an emphysema disorder, the alveolar wall of said components Ci of the alveolar sac type is affected very little or not at all. In order to assign a determined type to the different components Ci wherein the Feret diameter DFi is comprised within such an interval, from one hundred micrometres to one thousand micrometres, i.e. the components Ci of the bronchiolus, alveolus and/or alveolar sac type, said sub-step 1133 can consist of comparing the value CWWi of said component Ci estimated during step 112, to a high mean-thickness threshold CWWh of five micrometres. Thus, if such a mean thickness CWWi is less than said thickness threshold CWWh, then said sub-step 1133 may consist of assigning said predetermined value “1” in a dedicated field in the data structure associated with said component Ci. In the opposite case, if such a mean thickness CWWi is greater than said thickness threshold CWWh, then said sub-step 1133 may consist of assigning said predetermined value “2” in a dedicated field in the data structure associated with said component Ci. Such a predetermined value “1” may advantageously characterize a component Ci of the alveolus and/or alveolar sac type. Implementation of such a step 1133 can thus facilitate classification of the different types CTi of components Ci wherein the morphologies are similar, such as for example the components Ci of the bronchiolus type and of the alveolus and/or alveolar sac type. In fact, the total or partial destruction of the alveoli is characterized, on a digital representation RDI, MRI of a histological section of a lung affected by emphysema, by a significant reduction of the number of pixels describing components Ci of the alveolus type. It is therefore advantageous to characterize such alveolar sacs in order to be able to estimate the degree of severity with which a patient is suffering from a pathology such as emphysema, relative to the destruction of the alveoli constituting said alveolar sacs.

Advantageously but non-limitatively, as detailed above, said sequence of steps 110 can be implemented iteratively for one or more contours of one or more lumina CLi characteristic respectively of one or more identified components Ci. To this end, according to a non-limitative embodiment of a method 100 for producing a multiparameter graphic indicator I according to the invention described with reference to FIG. 8, such a step can also comprise a test step 111, so that when there is no longer any other contour encircling a lumen CLi characteristic of a still unidentified component Ci, situation illustrated by the link 111n in FIG. 8, estimation of one or more quantities of interest by iteration, as shown by the link lily between step 111 and step 114, comes to an end and the data relative to said quantities of interest are ready to be used by the sequence of steps 140 of the method 100 shown by way of non-limitative example in FIG. 8.

In order to facilitate the estimation of a quantity of interest with reference to the structure of the parenchyma of a lobe, said test step 111 can also be arranged to record the number of occurrences relative to the identification of a contour associated with a new lumen CLi characteristic of a component Ci, i.e. the number of iterations of the iterative sequence of steps 110.

As mentioned above, step 110 of a method 100 for producing a multiparameter graphic indicator I according to the invention can also comprise a step 114 for registering in the data memory a data structure associated with each identified component Ci, wherein the morphology was characterized during a step 112 of said method 100. Said data structure can advantageously comprise a field for storing the value of each corresponding estimated quantity of interest QI_{Ci} with reference to said component Ci, such as, for example, the Feret diameter DFi of said component Ci, a mean thickness CWWi of the wall CWi of said component Ci, the area ICAi describing the lumen CLi of said component Ci, the area OCAi describing the total area of said component Ci, the area CAi describing the total area of the wall CWi of said component Ci.

Thus, according to a preferred embodiment, a step 114 for registering, in the data memory, a data structure associated with each identified component Ci can consist of registering a predetermined value in a dedicated field of said data structure, such as by way of non-limitative example, the value “1” to characterize, based on one or more quantities of interest, a particular type CTi of component Ci, for example an alveolus and/or an alveolar sac.

In a variant or in addition, said data structure can comprise a field for storing the value corresponding to the number of occurrences or iterations relative to the identification of a component Ci within a digital representation RDI, MRI of a histological section of a lung.

At the end of an iterative sequence of steps 110 for estimating one or more quantities of interest QI with reference to the morphology of one or more components Ci, a method 100 can advantageously comprise a step 140 for producing a quantity of interest QI_{L} relative to the structure of the parenchyma of the lobe L. Similarly to the quantities of interest QI_{Ci} estimated relative to a component Ci, one or more quantities of interest QI_{L} of the lobe L and/or with reference to the structure of the parenchyma of said lobe L may be estimated. Such a step 140 can thus consist firstly of finding, in a step 141, in a digital representation RDI, MRI, the contour corresponding to the lobe L by the application of a technique such as that described by Satochi Suzuki et al. “Topological structural analysis of digitized binary images by border following”, Computer Vision, Graphics, and Image processing, 1985, or any other equivalent technique. By analogy with step 111 for finding a first lumen described by a component Ci, such a sub-step 141 can be arranged to determine the greatest contour, corresponding to a first polyline describing the outer contour associated with the lobe L, in a digital representation RDI, MRI of a histological section of a lung.

Secondly, said step 141 thus makes it possible to estimate, from said first polyline showing said outer contour of said lobe L, quantities of interest QI_{L} relative to the morphology of the lobe L, by analogy with the quantities of interest QI_{Ci} estimated during step 112 of a method 100 for producing a multiparameter graphic indicator. Such a step 141 can advantageously consist of estimating the area OCA_{L} described by the outer contour of said lobe L. An example for estimating such an area OCA_{L} can consist of adding the pixels having known dimensions describing the area delimited by said first polyline associated with said outer contour of said lobe L.

In a variant or in addition, said step 141 can consist of estimating a quantity of interest QI_{L} relative to the structure of the parenchyma of the lobe L, belonging to a set of quantities of interest comprising non-limitatively:
a lobe density ASNm, describing the number of components Ci occupying the surface area of a lobe L. Such a lobe density ASNm can be calculated as resultant of the number of identified components Ci, or the number of iterations of said step 112, divided by the area OCA_{L} of the lobe L such that

$$ASNm = \frac{{\sum }_{i = 1}^{n} Ci}{{OCA}_{L}} ;$$

in a variant, the invention provides the ability to express such a lobe density ASNm by unit of surface area of said lobe L. Such a lobe density can be expressed in order to describe the number of components Ci for a unit of area, as expressed by the above formula. The area OCA_{L} of the lobe L can be determined from the outer contour, or polyline, a histological section of a lung, such as the representations RDIa, RDIb, MRIa and/or MRIb, given with reference to FIGS. 1A, 1B, 2A and 2B. The area OCA_{L} of said lobe L then corresponds to the sum of the areas of all the pixels of known dimensions, said pixels being delimited or captured by said outer contour of said lobe L;
a void rate ASD of the lobe, describing the cumulative area covered by the set of the identified components Ci with respect to the area OCA_{L} of the lobe L. Said void rate ASD can be expressed by the following formula

$$ASD = \frac{{\sum }_{i = 1}^{n} ICAi}{{OCA}_{L}}$$

where iCAᵢ is the area covered by the lumen CLi of a component Ci;
a parenchyma rate TD, describing the area occupied by the parenchyma of a lobe L with respect to the area OCA_{L} of said lobe L. Said area of the parenchyma of the lobe L is obtained by subtracting the sum of the areas of the respective lumina CLi of the identified components Ci. Such a rate TD can also be expressed as the rate complementary to 1 of the preceding rate ASD and described by the following formula:

$$TD = 1 - ASD = 1 - \frac{{\sum }_{i = 1}^{n} ICAi}{{OCA}_{L}} .$$

Advantageously but non-limitatively, a method 100 for producing a multiparameter graphic indicator can comprise a filtering or selection step, not shown in FIG. 8, as in step 121 of a method 100, so as to take into account, among the morphological quantities of interest of all of the identified components, only the quantities of interest associated with a determined type CTi of components. In fact, it can be advantageous to estimate one or more quantities of interest QI_{L} taking into account only certain components Ci, according to said type CTi, in order to provide an aid to the diagnosis of a pathology such as, by way of non-limitative example, emphysema, or an analysis of the therapeutic efficacy of a molecule for combatting such a pathology. Such a step for filtering or selecting can thus consist of reading, in the data structure associated with each component Ci, the value present in the field characterizing the type CTi of said component Ci. By way of non-limitative example, such a step for filtering can advantageously be parameterized such that only the quantities of interest QI_{Ci} relative to the components Ci of type CTx “alveolus and/or alveolar sac” are used subsequently to produce a multiparameter graphic indicator I.

Advantageously but non-limitatively, a method 100 according to the invention can also comprise a step 142 for registering, in the data memory, a data structure associated with the structure of the parenchyma and wherein the quantities of interest QI_{L} have been estimated beforehand during step 141 of a method 100 in order to produce a multiparameter graphic indicator I. Said data structure can advantageously comprise a field for storing the value of each corresponding estimated quantity of interest QI_{L}, such as, by way of non-limitative example, the area OCA_{L} of the lobe L, a lobe density ASNm, a void rate of the lobe ASD or a parenchyma rate TD.

Moreover, in order to compare the values of the quantities of interest estimated beforehand to values of standard quantities of interest and finally to facilitate the production of a multiparameter graphic indicator I, it may be necessary to calculate or estimate one of the mean quantities of interest. Thus, a method 100 for producing a multiparameter graphic indicator I according to the invention can comprise a sequence of steps 120 for estimating one or more mean quantities of interest QI_{CTX} relative to a type of component Ci. In order to produce such estimations of such mean quantities of interest by type of component, the sequence of steps 120 of a method 100 can comprise a step 121 for filtering the data estimated beforehand and recorded in the data memory, making it possible to take account only of data relative to one or more determined types CTx from the set of values of types CTi of identified components Ci, in order subsequently to finally produce a multiparameter graphic indicator I relative to said data. By way of non-limitative example, such a step 121 can consist of reading, in the data structure associated with a component Ci, the value present in the field characterizing the type CTi of said component Ci. To this end, said step 121 can advantageously be parameterized such that only the data, more particularly the quantity or quantities of interest QI_{Ci} estimated beforehand relative to the components Ci of type CTx “alveolus and/or alveolar sac” associated with such a type of component Ci comprising, in the field characterizing the type CTi of said component Ci, a predetermined value CTx for example equal to “1”, are used to subsequently produce a multiparameter graphic indicator I, with a view to providing an aid in the diagnosis of a pathology such as, by way of non-limitative example, emphysema.

Thus, advantageously but non-limitatively, a method 100 for producing a multiparameter graphic indicator I according to the invention can comprise a step 122 for estimating a mean for each set of quantities of interest QI_{Ci} per type CTi of component Ci. Step 122 can thus produce, for a determined type CTx of components Ci optionally filtered beforehand during the implementation of step 121, one or more mean quantities of interest QI_{CTx}, from quantities of interest QI_{Ci} estimated respectively for all the components Ci. As mentioned above, by “set of quantities of interest QI_{Ci}” is meant all the values estimated beforehand, for example relative to:
the Feret diameter DFi of the outer contour CWOCi of the wall CWi for a given type CTi of component Ci;
the mean thickness CWWi separating an outer contour CWOCi from an inner contour CWICi for a given type CTi of component Ci;
the area ICAi of the lumen described by an inner contour CWICi for a given type CTi of component Ci;
the area OCAi described by an outer contour CWOCi for a given type CTi of component Ci;
the area CAi of the wall CWi defined by subtracting the area ICAi described by an inner contour CWICi from the area OCAi described by an outer contour CWOCi for a given type CTi of component Ci.

By way of non-limitative example, to produce a multiparameter graphic indicator I making it possible to characterize a pathology such as emphysema, step 122 of a method 100 for producing a multiparameter graphic indicator I according to the invention can consist of estimating, for a set of components Ci of the alveolus and/or alveolar sac type:
the mean Feret diameter DFm corresponding to the ratio between the sum of the Feret diameters DFi of the components Ci of the alveolus and/or alveolar sac type and the number of components Ci of the alveolus and/or alveolar sac type wherein a Feret diameter DFi was estimated beforehand;
the mean thickness CWWm corresponding to the ratio between the sum of the mean thicknesses CWWi of the components Ci of the alveolus and/or alveolar sac type and the number of components Ci of the alveolus and/or alveolar sac type wherein said thickness CWWi was estimated beforehand;
the mean area ICAm of the lumina CLi corresponding to the ratio between the sum of the estimated areas ICAi of the components Ci of the alveolus and/or alveolar sac type and the number of components Ci of the alveolus and/or alveolar sac type wherein the area ICAi was estimated beforehand;
the mean area OCAm corresponding to the ratio between the sum of the areas OCAi of all the components Ci of the alveolus and/or alveolar sac type and the number of components Ci of the alveolus and/or alveolar sac type wherein the area OCAi was estimated beforehand;
the mean area CAm of the wall CWi corresponding to the ratio between the sum of the areas CAi of all the components Ci of the alveolus and/or alveolar sac type and the number of component Ci of the alveolus and/or alveolar sac type wherein the area CAi was estimated beforehand.

Advantageously but non-limitatively, a method 100 according to the invention can also comprise a step 123 for registering, in the data memory, a data structure associated with a mean quantity of interest for each set of quantities of interest QI_{Ci} per type CTi of component Ci and wherein the quantities of interest QI_{CTx} were estimated beforehand in step 122 of a method 100 for producing a multiparameter graphic indicator. Said data structure can advantageously comprise a field for storing the value of each corresponding estimated quantity of interest QI_{CTx}, such as, by way of non-limitative example, a mean Feret diameter DFm, a mean thickness CWWm of the walls CWi, a mean area ICAm of the lumina CLi, a mean area OCAm of the components, a mean area CAm of the walls CWi, for a given type of components Ci.

Advantageously, a method 100 for producing a multiparameter graphic indicator I according to the invention can comprise a sequence of steps 150 consisting of producing one or more graphic representations, intended to transcribe one or more quantities of interest QI_{Ci}, QI_{CTx}, QI_{L} such as, by way of non-limitative example, the quantities of interest DFi, CWWi, ICAi, OCAi, CAi, DFm, CWWm, ICAm, OCAm, CAm, ASNm, ASD, ID, estimated beforehand, in a graphic form. Said method 100 can then comprise a sequence of steps 160 for producing the joint graphic rendering of said graphic representations produced beforehand during the implementation of the sequence of steps 150, and deliver a multiparameter graphic indicator I.

Preferentially but non-limitatively, a sequence of steps 150 of a method 100 for producing a multiparameter graphic indicator I according to the invention can consist of producing a graphic representation, for a type CTx of component Ci determined and/or selected beforehand by means of an input human-machine interface, a quantity of interest QI_{Ci}, QI_{CTx}, QI_{L} relative to a standard quantity of interest. By “standard quantity of interest” is meant a reference quantity of interest that can be optionally parameterized, associated with each estimated quantity of interest QI_{Ci}, QI_{CTx}, QI_{L}. According to the examples described above, such a standard quantity of interest can consist of, non-limitatively:
the mean Feret diameter DFe corresponding to the ratio between the sum of the Feret diameters DFi of the components Ci of the alveolus type and the number of components Ci wherein a Feret diameter DFi was estimated beforehand in a healthy patient;
the mean diameter CWWe corresponding to the ratio between the sum of the mean thicknesses CWWi of the components Ci of the alveolus type and the number of said components Ci wherein said thickness CWWi was estimated beforehand in a healthy patient;
the mean area ICAe of the lumina CLi corresponding to the ratio between the sum of the estimated areas ICAi of the components Ci of the alveolus type and the number of components Ci wherein the area ICAi was estimated beforehand in a healthy patient;
the mean area OCAe corresponding to the ratio between the sum of the areas OCAi of the components Ci of the alveolus type and the number of components wherein the area OCAi was estimated beforehand in a healthy patient;
the mean area CAe of the walls corresponding to the ratio between the sum of the areas CAi of the components Ci of the alveolus type and the number of components wherein the area CAi was estimated beforehand in a healthy patient.

A healthy patient is defined as a patient having no pathology affecting the airways, such as, by way of non-limitative example, emphysema. In this case, the graphic representations of the quantities of interest QI_{Ci}, QI_{CTx}, QI_{L} of a type CTi of component Ci and/or of a lobe L and/or of the structure of the parenchyma of said lobe L produced during the sequence of step 150 for producing a graphic representation and/or the sequence of steps 160 for producing a multiparameter graphic indicator I can be expressed as a relative or normalized value, thus allowing said quantities of interest to be expressed according to a common scale and consequently comparable together, such quantities of interest being preferentially but non-limitatively expressed as a percentage of the corresponding standard quantities of interest.

Preferentially, according to a first example of graphic representation described with reference to FIG. 4, such a sequence of step 150 can consist of producing a graphic representation in the form of a bar of a bar chart representing, for example, one of the quantities of interest QI_{Ci}, QI_{CTx}, QI_{L} estimated beforehand, wherein the height or the length, according to whether the bar is vertical or horizontal respectively, describes the relative value of said estimated quantity of interest with respect to said standard quantity of interest. Said graphic representation can moreover encode one or more data items determined for characterizing, during the display of said graphic representation via an output human-machine interface during the sequence of steps 160, more particularly step 162, a texture, a pattern or a particular contour, or any other data allowing an effect on the graphic rendering. Advantageously, in a variant, according to a second example of graphic representation described with reference to FIG. 5, a sequence of step 150 of a method 100 according to the invention can consist of producing a graphic representation in the form of a point on an axis of a radar chart representing, for example, one of the quantities of interest QI_{Ci}, QI_{CTx}, QI_{L} estimated beforehand, wherein the position on said axis describes the relative value of said estimated quantity of interest with respect to said standard quantity of interest. Thus, according to the first and second examples of graphic representations described respectively with reference to FIGS. 4 and 5, the estimated quantities of interest TD, ASD, DFm and ASNm for a determined type CTx of component Ci, of a digital representation of a histological section of a lobe of a lung of a patient examined, can be compared together and respectively to the standard quantities of interest TDe, ASDe, DFe and ASNe corresponding to a healthy patient.

According to a preferred, but non-limitative, embodiment of a method 100 for producing a multiparameter graphic indicator I according to the invention, the production of the graphic representations during the sequence of step 150 of said method 100 will be described for a type of component Ci of interest in the form of an alveolus and/or an alveolar sac, with a view to producing a multiparameter graphic indicator I. Such a multiparameter graphic indicator I is described in particular with reference to FIGS. 4, 5, 6 and 7, after implementation of the sequence of steps 160, more particularly step 162 for producing the joint graphic rendering of the graphic representations of the quantities of interest, such as, for example, the quantities of interest TD, ASD, DFm and ASNm relative to the quantities of interest TDe, ASDe, DFe and ASNe in a healthy patient. Advantageously, said quantities of interest TD, ASD, DFm and ASNm can be expressed respectively as a percentage or normalized with respect to a standard quantity of interest, the numerical value of the percentage being juxtaposed with the digital representation in question. In a variant or in addition. a grid symbolized, for example, by axes “50% CTL” and “100% CTL” described as “normalized bars”, as shown with reference to FIG. 4, or by lines graduated in twenties, described as “normed axes” as shown with reference to FIG. 5, may be superposed on the graphic representations during the sequence of steps 160. An investigator can thus instantly observe whether the quantities of interest TD, ASD, DFm and ASNm characterizing the mean morphology of the components of the alveolus and/or alveolar sac type and/or the structure of the parenchyma of the lobe L present in a digital representation of a histological section of a lung are different or not from the standard quantities of interest observed in a healthy patient.

FIG. 4 shows a first, non-limitative, example of graphic representation, in the form of a bar chart, of a multiparameter graphic indicator produced by a method according to the invention, said indicator describing a plurality of estimated quantities of interest relative to a plurality of respective standard quantities of interest on normed axes, in a patient suffering from emphysema. According to this first example, according to FIG. 4, such a sequence of step 150 can consist of expressing a first quantity of interest TD, in the form of a bar, with respect to a standard quantity of interest TDe, symbolized by the axis “100% CTL” of the grid. Thus, the graphic representation TD encodes a numerical value of eighty-five percent, meaning that the parenchyma rate TD in the patient examined is fifteen percent less with respect to the parenchyma rate in a healthy patient. Similarly, and independently of the graphic representation of the first quantity of interest TD, the sequence of step 150 can advantageously consist of expressing a second quantity of interest ASD, in the form of a bar, with respect to a standard quantity of interest ASDe, symbolized by the axis “100% CTL” of the grid. Thus, the graphic representation ASD encodes a numerical value of one hundred and ten percent, meaning that the void rate ASD in the patient examined is ten percent greater with respect to the void rate in a healthy patient. Similarly, and independently of the respective graphic representations of the first and second quantities of interest TD and ASD, the sequence of step 150 can advantageously consist of expressing a third quantity of interest DFm, in the form of a bar, with respect to a standard quantity of interest DFe, symbolized by the axis “100% CTL” of the grid. Thus, the graphic representation DFm encodes a numerical value of one hundred and fifteen percent, meaning that the mean Feret diameter DFm of the components Ci of the alveolus type in the patient examined is fifteen percent greater with respect to the mean diameter DFe of the alveoli in a healthy patient. Similarly, and independently of the respective graphic representations of the first, second and third quantities of interest TD, ASD and DFm, the sequence 150 can advantageously consist of expressing a fourth quantity of interest ASNm, in the form of a bar, with respect to a standard quantity of interest ASNe, symbolized by the axis “100% CTL” of the grid. Thus, the graphic representation ASNm encodes a numerical value of fifty-three percent, meaning that the density of the lobe ASNm in the patient examined is forty-seven percent less with respect to the density of the lobe ASNe in a healthy patient. It will thus be possible, during the implementation of the sequence of steps 160, to produce the joint graphic rendering of said thus-produced graphic representations via an output human-machine interface of a system implementing a method 100 according to the invention, in the form, for example, of bar charts, in order to provide an investigator with a multiparameter graphic indicator I, showing the different bars side by side.

Such a first example of joint graphic rendering, in the form of a bar chart, is shown in FIG. 4 for a patient suffering from emphysema. Thus, said FIG. 4 expresses jointly the respective graphic representations of the first, second, third and fourth quantities of interest TD, ASD, DFm, and ASNm in the form of a graphic representation of the bar chart type, and expressing the respective values of said quantities of interest TD, ASD, DFm and ASNm relative to those of the same quantities of interest TD, ASD, DFm, et ASNm in a healthy patient. An investigator can thus, by simply displaying the multiparameter graphic indicator I, easily take into account that the mean quantities of interest TD, ASD, DFm, and ASNm in a patient examined are less than or greater than the corresponding standard quantities of interest TDe, ASDe, DFe, and ASNe in a healthy patient. Such a multiparameter graphic indicator I is then capable of providing a valuable aid to an investigator or a member of healthcare personnel, in order to diagnose, optionally, a pathology affecting the pulmonary tract, such as emphysema for example. In fact, a multiparameter graphic indicator I, as shown with reference to FIG. 4, provides relevant information relating to the general morphology of all the components of the alveolus and/or alveolar sac type as well as the structure of the parenchyma of a lobe L observed in a digital representation of a histological section of a lung of a patient suffering from emphysema. Such a disorder generally results in a more or less heterogenous total or partial destruction of the walls of the pulmonary alveoli, i.e. a reduction of the density of the lobe ASNm as well as the parenchyma rate TD. This destruction of the alveolar wall consequently results in an increase of the Feret diameter DFi of the area ICAi of the lumen CLi of the components Ci of alveolus and/or alveolar sac type, therefore of the void rate of the lobe ASD, and more generally of the size of the components Ci of the alveolus type. Such a multiparameter graphic indicator I, as shown in FIG. 4, thus makes it possible to provide an investigator instantly with a state of the small airways of the lungs of a patient. The destruction of the walls CWi of the components Ci of the alveolus type, within the context of a patient suffering from emphysema, will result in significant reduction of the number of identified components Ci of the alveolus type. In fact, the destruction of the alveoli generally has the consequence of allowing the identification of the alveolar sacs, the walls of which remain intact instead of said destroyed alveoli that are observed, in a healthy patient, within said alveolar sacs. Similarly, the predominant identification of said alveolar sacs results in an increase of the mean Feret diameter DFm of the components Ci of alveolus and/or alveolar sac type, since all or part of the pulmonary alveoli wherein the wall has been destroyed, are not made evident by a method according to the invention. In sum, in the context of emphysema, the identified components Ci of the alveolus type are generally alveolar sacs wherein the alveoli have been destroyed. Thus, a reduction of the density of the lobe ASNm will characterize a reduction of the number of contours identified with respect to the components Ci of the alveolus type on a digital representation RDI, MRI of a histological section of a lung of a patient suffering from emphysema, revealing destruction of said alveoli.

The invention makes it possible moreover to produce an aid complementary to such a multiparameter graphic indicator I. In fact, the implementation of a method 100, as described above, makes it possible to distinguish between the identified components Ci in a digital representation RDI or MRI of a histological section, the airspaces, i.e. alveolar spaces, in particular constituted by the alveoli within the parenchyma. By virtue of the classification of the components Ci of interest, step 112 calculates the area OCAi of each of said components of interest, in this case the alveoli. A method 100 according to the invention can thus implement a step, not shown in FIG. 8 for reasons of simplicity, for estimating a distribution of the frequency of occurrence of such components of interest (airspaces) according to the sizes or areas thereof. In fact, the invention provides for the ability to distribute, over a determined number of classes, for example fifteen, said alveolar spaces Ci according to the respective areas OCAi thereof. Thus, according to a non-limitative example with reference to the analysis of a lung of a mouse, a method according to the invention can record separately the alveolar spaces wherein the areas are:
less than 32 square micrometres (μm²)—class cl1;
greater than 32 μm² and less than 64 μm²—class cl2;
greater than 64 μm² and less than 128 μm²—class cl3;
. . .
greater than 2048 μm² and less than 4096 μm²—class cl7;
. . .
greater than 262144 μm² and less than 524288 μm²—class cl15.

With such differentiated recording, a method according to the invention comprises a step for estimating a complementary quantity of interest with reference to the parenchyma consisting of a distribution of the frequency of occurrence of the alveolar spaces according to the areas thereof. Such a quantity of interest can for example consist of a distribution curve such as that shown in FIG. 9A. According to this figure, the classes cl1 to cl15 constitute the x-axis of a diagram wherein the y-axis corresponds to the number of alveolar spaces belonging to one of said classes divided by the total number of airspaces identified in a digital representation RDI or MRI of a histological section.

Such a quantity of interest in the form of the frequency distribution can be delivered visually to an investigator concomitantly with the aforementioned multiparameter graphic indicator I with reference to step 160 for causing rendering or graphic output of graphic representations produced beforehand. When such a frequency distribution according to the area of the alveolar spaces is delivered together with a standard frequency distribution corresponding to a healthy patient, as indicated in FIG. 9A by the curves DFp (patient examined) and DFc (healthy patient), an investigator can perfectly distinguish any remodelling of the very small-size components that cannot be identified and quantified according to the state of the art from a histological section. Such a complementary quantity of interest can confer a particularly valuable additional aid to an investigator in order for the latter to be able to perfect their diagnosis. Thus, according to FIG. 9A, it can reveal and quantify a clear reduction, with respect to a healthy patient, of the frequency of the very small-size components (classes c13 and c14) and an increase of the frequency of greater classes (such as classes c16 to c111), symptomatic of emphysema.

In a variant or in addition, such a distribution of the frequency of the areas of alveolar spaces expressed with respect to a standard distribution with reference to a healthy patient, as shown in FIG. 9A by way of non-limitative example, can also be revealed in a graphic representation in the form of a curve, as indicated by way of non-limitative example in FIG. 9B, or a bar graph expressing, relatively and/or as a percentage, class by class, an increase or regression of said frequency distribution of a patient analyzed with respect to a standard frequency distribution of a healthy patient, in order to further aid an investigator in their reading or analysis of a result such as that shown in FIG. 9A.

A method for producing such a multiparameter graphic indicator I, such as the method 100 shown in FIG. 8, can moreover, or in a variant, comprise a step, not shown in FIG. 8, for estimating a quantity of interest, complementary to such a multiparameter graphic indicator I, in the form of a total perimeter of the set of perimeters of components of interest Ci of a given type CTi, in this case the alveolar spaces or airspaces. Such a quantity of interest can result from the sum of the respective perimeters of the inner contours CWICi of the components Ci, encircling a lumen CLi. Such a quantity of interest can be used by an investigator for estimating the gaseous exchange capacity of the patient examined. To this end, a method according to the invention, such as the method 100 shown in FIG. 8, can moreover comprise a step, not shown in said figure, for producing a graphic representation revealing such a quantity of interest, said graphic representation capable of being delivered to said investigator in step 160 of said method via the output interface of the device or of the electronic object implementing such a method 100.

In a variant or in addition, in order to reinforce the visual discrimination of a multiparameter graphic indicator I relative to remodelling of the human or animal alveolar epithelium, the sequences of steps 150 and/or 160 of a method for producing such a multiparameter graphic indicator I can, by way of non-limitative example, consist of expressing, then displaying, averaged quantities of interest, in the form of a graphic representation of the radar chart type, also known as a Kiviat diagram, with respect to or relative to these same standard quantities of interest, said standard quantities of interest being indicated as corresponding to 100% relative to a graduated axis. Such an axis can be graduated, by way of non-limitative example, from zero percent of the value of the corresponding standard quantity in a healthy patient. Thus, each quantity of interest QI can be normalized with respect to the corresponding standard quantity of interest, and they can be capable of being displayed after graphic rendering during the sequence of steps 160 in a continuous scale. Such a radar chart describes at least three respective graphic representations of three quantities of interest. FIG. 5 shows a second non-limitative example of graphic representation in the form of a radar chart of a multiparameter graphic indicator I produced by a method 100 according to the invention, said indicator describing a plurality of estimated quantities of interest relative to a plurality of respective standard quantities of interest on normed axes, in a patient suffering from emphysema.

According to this second example, according to FIG. 5, such a sequence of step 150 can consist of expressing a first quantity of interest DFm, in the form of a position on a graduated axis, with respect to a standard quantity of interest DFe, symbolized by the position 100 on the graduated axis. Similarly, and independently of the graphic representation of the first quantity of interest DFm, the sequence of step 150 can advantageously consist of expressing a second quantity of interest ASD, in the form of a position on a graduated axis, with respect to a standard quantity of interest ASDe, symbolized by the position 100 on the graduated axis. Similarly, and independently of the respective graphic representations of the first and second quantities of interest DFm and ASD, the sequence of step 150 can advantageously consist of expressing a third quantity of interest ASNm, in the form of a position on a graduated axis, with respect to a standard quantity of interest ASNe, symbolized by the position 100 on the graduated axis.

It will thus be possible, during the sequence of steps 160, more particularly during the step 162, to cause the joint graphic outputting of said thus-produced graphic representations via an output human-machine interface of a system implementing a method 100 according to the invention, such as, by way of non-limitative example, in the form for example of a radar chart, in order to provide an investigator with a multiparameter graphic indicator I. Such a joint graphic rendering can moreover show the materialization of an area defined by the respective different positions of the normalized quantities of interest on the normed axes. Such a first example of joint graphic rendering, in the form of a radar chart, is shown in FIG. 5 for a patient suffering from emphysema. Thus, said FIG. 5 expresses jointly the graphic representations of the first, second and third quantities of interest DFm, ASD, and ASNm in the form of a graphic representation of the radar chart type. The area describing the joint positions of the quantities of interest DFm, ASD, and ASNm delimited by a dotted contour, can thus easily indicate the pathological state of the morphology of the components Ci of interest and/or of the structure of the parenchyma of the lobe represented on each axis of the diagram with respect to the area, indicated by the solid line contour, describing a morphology of such components and a typical structure of the parenchyma in a healthy patient. It is thus easier for the investigator to perceive the distance or the deviation between the pathological state of the morphology and/or of the structure of the parenchyma of the lobe, described by the area delimited with a dotted line, of a patient examined, with respect to a morphology and/or a structure of the parenchyma of said lobe in a healthy patient. In this case, according to the example shown in FIG. 5, the components Ci of interest of the alveolus and/or alveolar sac type, present in a digital representation of a histological section of a lung, have quantities of interest DFm, ASD that have increased and a quantity of interest ASNm that has decreased with respect to the same standard quantities of interest.

FIG. 6 shows a third, non-limitative, example of graphic representation, in the form of a bar chart, of a multiparameter graphic indicator produced by a method according to the invention, said indicator describing a plurality of estimated quantities of interest relative to a plurality of respective standard quantities of interest on normed axes, in a patient suffering from emphysema. As in FIG. 4, FIG. 6 expresses jointly respective graphic representations of the first, second, third and fourth quantities of interest TD, ASD, DFm, and ASNm in the form of a graphic representation of the bar chart type. However, FIG. 6 shows respective graphic representations of the first, second, third, and fourth quantities of interest TD, ASD, DFm and ASNm in the form of signed relative deviations, such deviations consisting of positive or negative numerical values calculated from the following mathematical formula for each quantity of interest QI:

$$Em = \frac{QIm - QIe}{QIe} ,$$

wherein Em consists of the value of the estimated mean deviation, QIm consists of the value of the estimated quantity of interest in a patient examined, QIe consists of the value of the standard quantity of interest in a healthy patient.

According to this third example, according to FIG. 6, such a sequence of step 150 can consist of expressing signed relative deviations between the first, second, third and fourth quantities of interest TD, ASD, DFm and ASNm respectively in the form of bars, with respect to a vertical or horizontal zero datum plane described by an axis “100% CTL”. Such deviations can thus represent a relative or normalized reduction or increase of said first, second, third and fourth quantities of interest TD, ASD, DFm and ASNm, with respect to respective standard quantities of interest. In this case, for a vertical plane, a reduction of such a quantity of interest is displayed on the left, while an increase of such a quantity of interest is displayed on the right.

It will thus be possible, during the implementation of the sequence of steps 160, more particularly step 162, to cause the joint graphic outputting of said thus-produced graphic representations via an output human-machine interface of a system implementing a method 100 according to the invention, in the form, for example, of bar charts, in order to provide an investigator with a multiparameter graphic indicator I, showing the different bars side by side.

FIG. 7 shows a fourth non-limitative example of graphic representation in the form of a radar chart of a multiparameter graphic indicator I produced by a method 100 according to the invention, said indicator describing a plurality of estimated quantities of interest relative to a plurality of respective standard quantities of interest on normed axes, in a patient suffering from emphysema. As in FIG. 4, FIG. 7 expresses jointly respective graphic representations of the first, second and third quantities of interest DFm, ASD, and ASNm in the form of a graphic representation of the radar chart type. However, FIG. 7 shows respective graphic representations of the first, second, and third quantities of interest DFm, ASD and ASNm in the form of signed absolute deviations, such deviations consisting of positive or negative numerical values calculated from the following mathematical formula for each quantity of interest QI_{CTx}, QI_{Ci} and/or QI_{L}:

$$Em = QIm - QIe \to \{ \begin{matrix}Em < 0 \to Em = 0.1 \\ Em \approx 0 \to Em = 0.5 \\ Em > 0 \to Em = 1\end{matrix}$$

wherein Em consists of the value of the estimated mean deviation value, QIm consists of the value of the estimated quantity of interest in a patient examined, QIe consists of the value of the standard quantity of interest in a healthy patient. Such a fourth example of graphic representation, in the form of a radar chart, proves particularly advantageous, since such a graphic representation allows an investigator to easily visualize graphically any significant difference between estimated quantities of interest QI_{CTx}, QI_{Ci} and/or QI_{L} and standard quantities of interest QI, even where these are relatively similar.

According to this fourth example, according to FIG. 7, such a sequence of step 150 can consist of expressing absolute deviations determined between the first, second and third mean quantities of interest DFm, ASD and ASNm and first, second and third corresponding respective standard quantities of interest, respectively in the form of positions on graduated axes. Such deviations can thus represent a normalized absolute reduction or increase, in this case according to three predetermined increasing values, “0.1”, “0.5” and “1” of said first, second and third quantities of interest DFm, ASD and ASNm, with respect to respective standard quantities of interest. However, the invention should not be limited to the predetermined values of the deviations Em. Advantageously, the deviations or said quantities of interest DFm, ASD and ASNm can be expressed respectively by a value characterizing a reduction, an equivalence or an increase with respect to a standard quantity of interest, in this case such an equivalence to a standard quantity of interest is shown on each axis of the chart, by the corresponding “0.5” graduation. Thus, the invention provides a threshold of tolerance that can be parameterized or predetermined, for example plus or minus ten percent around the standard value for thus determining such an equivalence between the estimated quantity of interest and the corresponding standard quantity. Similarly, the invention provides that below such a threshold, said quantity of interest is considered to be less, value “0.1”, or greater, value “1”, than said standard quantity of interest. In order to visualize graphically a difference considered significant by the investigator, such a fourth example of graphic representation, in the form of a radar chart, can advantageously be arranged to display an increase or a decrease for each estimated quantity of interest QI_{Ci}, QI_{CTx}, QI_{L} with respect to a standard quantity of interest if, and only if, said quantity of interest QI_{Ci}, QI_{CTx}, QI_{L} is greater or less than a threshold capable of being parameterized.

In this case, according to FIG. 7, a reduction is observed in the third quantity of interest ASNm, said deviation with reference to said third quantity of interest being equal to “0.1”. It will thus be possible, during the sequence of steps 160, more particularly step 162, to cause the joint graphic outputting of said thus-produced graphic representations via an output human-machine interface of a system implementing a method 100 according to the invention, such as, by way of non-limitative example, in the form of a radar chart, in order to provide an investigator with a multiparameter graphic indicator I. The radar chart shown, with reference to FIG. 7, thus directly describes a reduction of the quantity of interest ASNm, a reduction of such a quantity of interest being displayed on the graduation “0.1” of the corresponding axis, while the increases of the quantities of interest DFm, ASD are displayed on the graduation “1” of the corresponding axis.

Such a joint graphic outputting can moreover show the materialization of an area defined by the different respective positions of the normalized quantities of interest on the normed axes. Such a first example of joint graphic output, in the form of a radar chart, is shown in FIG. 5 for a patient suffering from emphysema. As in FIG. 5, the area, describing the joint positions of the quantities of interest DFm, ASD and ASNm delimited by a dotted contour, can thus easily indicate the pathological state of the morphology of the components Ci of interest and/or of the structure of the parenchyma of the lobe L represented on each axis of the diagram with respect to the area, indicated by the solid line contour, describing a typical morphology of such components in a healthy patient.

Use of such a radar chart makes it possible, moreover, to directly compare quantities of interest QI_{Ci}, QI_{CTx}, QI_{L} that are intended to be correlated with one another. In fact it is known that a pathology such as emphysema can result in total or partial destruction of the alveoli. Thus, the production of a multiparameter graphic indicator I in the form of a radar chart makes it possible to visually highlight an increase of the Feret diameter DFm of the components Ci of the alveolus type as well as the structure of the parenchyma of the lobe, revealing total or partial destruction of said alveoli described respectively, with reference to FIG. 7, by the density of the lobe ASNm and the void rate of the lobe ASD.

To this end, the sequence of steps 160 of a method 100 according to the invention can comprise a step 162 for causing the rendering or graphic output of a multiparameter graphic indicator I according to the invention by means of a suitable human-machine interface, for example a computer screen, cooperating with the electronic object implementing said method 100. In a variant or in addition, such rendering or output can be in writing, via an output peripheral of the printer type, or even acoustic, via an output peripheral of the loudspeaker type.

In a variant or in addition to the step 162, the sequence of steps 160 of a method 100 for producing a multiparameter graphic indicator I according to the invention can comprise one or more steps 161, 163, 164, 165 for causing a graphic outputting respectively of digital representations of the RDI, MRI type such as the representations RDIa, RDIb, MRIa, MRIb and estimated quantities of interest QI_{Ci}, QI_{CTx}, QI_{L} in the form of maps. Such maps can be returned graphically by means of an output peripheral, the same as, or different from, the aforementioned one delivering the multiparameter graphic indicator I, quantity of interest by quantity of interest during the implementation of the sequence of steps 120.

In this way, the user of an electronic object capable of implementing a method according to the invention such as the method 100, has available a plurality of objective, reproducible and instant information aiding the diagnosis of a pathology such as emphysema. The set of steps 161 to 165 thus constitute a sequence of steps 160, intended to output to the user a multiparameter graphic indicator I, one or more estimated quantities of interest QI_{Ci}, QI_{CTx}, QI_{L}, or one or more maps, in this case, one or more digital representations from the aforementioned digital representations RDIa, RDIb, MRIa, MRIb.

Alternatively, instead of the implementation of the sequences of steps 120 and/or 140, the invention provides for the implementation of a sequence of steps 130 of a method 100 according to the invention. Such a sequence comprises a step of selection 131 of a particular component Ci from those present in a digital representation RDI, MRI of a histological section. Such a selection involves human intervention via a human-machine interface suitable for a user instead of automatic “filtering” that is predetermined or parameterized for a given type CTx of components. Such an intervention of a user can consist of selecting a component Ci from a digital representation RDI, MRI or also directly in a data structure associated with said component Ci, via any type of human-machine interface, such as, by way of non-limitative example, a screen, a keyboard, a pointing device or a touch screen. In this case, the invention provides for the ability to compare the quantities of interest QI_{Ci} to the corresponding standard quantities of interest in a healthy patient, or in a variant to the estimated mean quantities of interest QI_{CTx} in this same patient for the set of components Ci associated with the same type of components as the selected component Ci. Furthermore, the invention provides that one or more steps of graphic rendering 163 or 164 of a method 100 according to the invention can consist moreover of assigning, to the pixels associated with a component of interest Ci, a determined colour and/or value expressing a significant increase or decrease with respect to the mean morphology of the other components Ci of one and the same type.

The invention has been described in particular with reference to analysis of a pulmonary lobe of a mouse. However, it should not be limited to this embodiment example and/or application alone. Other modifications may be envisaged, without departing from the scope of the present invention, in order to adapt the method, in a variant or in addition, to produce a multiparameter graphic indicator in a human being or another animal, or to an organ having anatomical similarities with the lung.

Furthermore, the invention should not be limited only to graphic representations in the form of the aforementioned bar charts and/or radar charts, wherein the quantities of interest are expressed in particular as a function of standard quantity of interest. In a variant, other representations capable of producing a multiparameter graphic indicator I could have been used.

The invention should not be limited only to graphic representations in the form of bar charts and/or radar charts wherein the quantities of interest are expressed in particular as a function of standard quantity of interest, other graphic representations as well as other quantities of interest could have been chosen in a variant of said graphic representations, independently of those presented with reference to FIGS. 4 to 7, in order to produce a multiparameter graphic indicator I.

1. Method for producing a multiparameter graphic indicator relative to a remodelling of the human or animal alveolar epithelium from a digital representation of a histological section of a pulmonary lobe, such a digital representation comprising an array of a determined number of pixels which describe one or more components having annular shapes, within the parenchyma of said lobe, each of said one or more components having a wall encircling a lumen, said method being implemented by a processing unit of a system for histological analysis, said system moreover comprising an output human-machine interface and a data memory, wherein said method comprises:
estimating a quantity of interest relative to the morphology of each component identified in the digital representation of the histological section, said quantity of interest belonging to a set of quantities of interest comprising:
i. the Feret diameter of the outer contour of the wall of a component;
ii. a mean distance separating said outer contour from the inner contour, describing a mean thickness of the wall of a component;
iii. the area described by said inner contour of a component, describing the area of the lumen thereof;
iv. the area described by said outer contour of a component, describing the total area covered thereby;
estimating a quantity of interest relative to the structure of the parenchyma of the lobe, said quantity of interest belonging to a set of quantities of interest comprising:
i. a lobe density, corresponding to a ratio between a number of identified components in the digital representation of the histological section and the area of the lobe;
ii. a void rate of the lobe, corresponding to a ratio between the sum of the areas of the respective lumina of the identified components in the digital representation and the area of the lobe;
iii. a parenchyma rate, corresponding to the area described by the parenchyma with respect to the area of the lobe;
producing, per estimated quantity of interest, a graphic representation thereof relative to a standard quantity of interest; and
causing the joint graphic outputting of the graphic representations of said quantities of interest relative to the respective standard quantities of interest produced beforehand, by the output human-machine interface of the system.

2. Method according to claim 1, wherein the step for estimating a quantity of interest relative to the morphology of a component and/or to the structure of the parenchyma of the lobe comprises a subsequent step for registering, in the data memory, a data structure associated with each component and/or with the lobe, said data structure comprising a field for storing the value of the estimated quantity of interest.

3. Method according to claim 1, comprising a step for characterizing a type of component identified in the digital representation of the histological section based on the value of one of the estimated quantities of interest (QI_{Ci}), the step for registering in the data memory a data structure associated with each estimated quantity of interest relative to the morphology of a component comprises registering in a field of said data structure a value characterizing a determined type of component.

4. Method according to claim 3, wherein, when an estimated quantity of interest relative to the morphology of a component comprises the Feret diameter of the outer contour of the wall of said component for characterizing a type of component comprises an operation of comparison of the value of said estimated Feret diameter to a high-diameter threshold and/or a low-diameter threshold.

5. Method according to claim 3, wherein, when an estimated quantity of interest relative to the morphology of a component comprises the mean thickness of the wall of the component, the step for characterizing a type of component comprises an operation of comparison of the value of said mean thickness to a predetermined high-thickness threshold and/or low-thickness threshold.

6. Method according to claim 3, wherein the step for producing, per estimated quantity of interest, a graphic representation thereof relative to a standard quantity of interest and/or the step for causing the joint graphic outputting of the graphic representations of said quantities of interest relative to the standard quantities of interest are only implemented for a determined characterized type of component.

7. Method according to claim 6, wherein the type of determined characterized component is a pulmonary alveolus and/or an alveolar sac.

8. Method according to claim 1, wherein the step for causing the joint graphic outputting of the graphic representations of said quantities of interest relative to the respective standard quantities of interest, produced beforehand by the output human-machine interface of the system, comprises the display by the latter of a radar chart, showing at least three graphic representations of quantities of interest relative to the respective standard quantities of interest on normalized axes.

9. Method according to claim 1, wherein the step for causing the joint graphic outputting of the graphic representations of said quantities of interest relative to the respective standard quantities of interest, produced beforehand by the output human-machine interface of the system, comprises the display by the latter of a bar chart, showing the graphic representations of quantities of interest relative to the respective standard quantities of interest by normalized bars.

10. Method according to claim 8, wherein the normalization of an axis or of a bar comprises expressing the value of an estimated quantity of interest as a percentage of the value of the associated standard quantity of interest.

11. Method according to claim 9, wherein the normalization of an axis or of a bar comprises expressing the value of an estimated quantity of interest relative to the value of the associated standard quantity of interest in the form of three predetermined values respectively describing estimated quantity of interest values substantially less than, similar to or greater than the values of the associated standard quantities of interest.

12. Electronic object of a system for histological analysis, said electronic object comprising a processing unit and cooperating with an output human-machine interface and with a data memory, and wherein said data memory comprises:
a digital representation of a histological section of a human or animal organ;
instructions that can be executed or interpreted by the processing unit, wherein the interpretation or execution of said instructions by said processing unit causes implementation of the method according to claim 1.

13. System for histological analysis comprising an electronic object according to claim 12, and an output human-machine interface capable of returning to a user a multiparameter graphic indicator according to said method and implemented by said electronic object.

14. A non-transitory computer program product comprising one or more instructions that can be interpreted or executed by a processing unit of an electronic object according to claim 12, wherein the interpretation or execution of said instructions by said processing unit causes the implementation of said method.
